(19) United States
(12) Patent Application Publication
(10) Pub. No.: US 2004/0166329 A1
(43) Pub. Date: Aug. 26, 2004

(54) Method for fabricating a thin line structure, multilayered structure and multilayered intermediate structure

(75) Inventors: Akira Sakai, Nagoya City (JP); Shigeaki Zaima, Kasugai City (JP); Yukio Yasuda, Aichi-Gun (JP); Osamu Nakatsuka, Nagoya City (JP)

Correspondence Address: OLIFF & BERRIDGE, PLC, P.O. BOX 19928, ALEXANDRIA, VA, 22320, US

(73) Assignee: NAGOYA UNIVERSITY, Nagoya City (JP)

(21) Appl. No.: 10/660,578

(22) Filed: Sep. 12, 2003

(30) Foreign Application Priority Data
Feb. 20, 2003 (JP) 2003-42275

(51) Int. Cl. B32B 15/00

(52) U.S. Cl. 428/432; 428/433

(57) ABSTRACT

On a given silicon substrate is epitaxially grown a strain-relaxed silicon germanium layer with penetrated dislocations and formed a metallic layer to form a multilayered intermediate structure, which is heated. In this case, metallic elements of the metallic layer are diffused through the penetrated dislocations of the silicon germanium layer to form a thin line structure made of metallic silicide at a boundary face between the silicon base and the silicon germanium layer.

### BACKGROUND OF THE INVENTION

1. Field of the Invention

This invention relates to a method for fabricating a thin line structure and a multilayered structure containing the thin line structure which are preferably usable in semiconductor device engineering. This invention also relates to a multilayered intermediate structure which is usable for fabricating the thin film structure and the multilayered structure.

2. Description of the Related Art

In the fabrication of a wiring pattern in a semiconductor element, first of all, a minute pattern is made by means of photoresist and then, the wiring pattern is made by means of deposition of a metallic layer commensurate with the photoresist pattern. In the fabrication of a multilayered wiring pattern, a plurality of wiring patterns are made and then, a plurality of protective insulating layers are made in order to electrically insulate the adjacent wiring patterns, respectively.

In the conventional process, however, many fabricating steps are required, so that the total fabricating process becomes complicated. In addition, in the fabrication of the multilayered wiring structure, it is required that an upper wiring pattern is formed precisely on a lower wiring pattern, so that the total fabricating process of the multilayered wiring structure becomes difficult.

### SUMMERY OF THE INVENTION

It is an object of the present invention to form a thin line structure such as a wiring pattern by means of easy means.

For achieving the above object, this invention relates to a method for fabricating a thin line structure, comprising the steps of:

preparing a given silicon base,

forming, on the silicon base, a strain-relaxed silicon germanium layer with penetrated dislocations,

forming a metallic layer on the silicon germanium layer to form a multilayered intermediate structure which is made of the silicon base, the silicon germanium layer and the metallic layer,

and

heating the multilayered intermediate structure to diffuse metallic elements of the metallic layer through the penetrated dislocations of the silicon germanium layer and to form a thin line structure made of metallic silicide at a boundary face between the silicon base and the silicon germanium layer.

This invention also relates to a multilayered intermediate structure comprising:

a given silicon base,

a strain-relaxed silicon germanium layer with penetrated dislocations which is formed on the silicon base,

and

a metallic layer which is formed on the silicon germanium layer.

The inventors had intensely studied to achieve the above-mentioned objects. As a result, they found out the following fact of the matter.

First of all, a multilayered intermediate structure is made of a silicon base, a strain-relaxed silicon germanium layer with penetrated dislocations and a metallic layer, and heated to diffuse metallic elements of the metallic layer to the boundary face between the silicon base and the silicon germanium layer through the penetrated dislocations of the silicon germanium layer. In this case, the metallic elements are reacted with silicon elements of the silicon base and/or silicon germanium layer to form a thin line structure made of metallic silicide at the boundary face.

According to the present invention, therefore, the intended thin line structure can be formed at the boundary face, that is, on the silicon base only by the above-mentioned strain-relaxed silicon germanium layer without a conventional complicated pattern-forming technique. If necessary, the silicon germanium layer can be peeled off by means of a conventional technique such as lift-off means or etching means, to expose the thin line structure. As a result, various semiconductor elements can be made by utilizing the thin line structure of the present invention.

The strain-relaxed silicon germanium layer can be made by means of a conventional epitaxial growth technique if the germanium content of the silicon germanium layer is adjusted appropriately. As the germanium content of the silicon germanium is increased, the difference in lattice constant between the silicon base and the silicon germanium layer is increased, so if the silicon germanium layer with large amount of germanium is formed on the silicon base, misfit dislocations are created at the boundary face between the silicon base and the silicon germanium layer in order to relax the difference in lattice constant therebetween.

The misfit dislocations are propagated upward with the progress of the epitaxial growth of the silicon germanium layer to form penetrated dislocations in the epitaxially grown silicon germanium layer, and thus, complete the strain-relaxed silicon germanium layer.

The density of the thin line structure, formed at the boundary face between the silicon base and the silicon germanium layer, depends on the density of the penetrated dislocations of the silicon germanium layer. Therefore, it is required to design the density of the penetrated dislocations so as to realize the intended density of the thin line structure. Concretely, in order to design the intended density of the penetrated dislocations, the forming method and the forming condition of the silicon germanium layer are adjusted, and the germanium content of the silicon germanium layer is adjusted. In order to change the density of the penetrated dislocations widely, it is desired to control the germanium content of the silicon germanium layer.

Other features and advantages of the present invention will be described hereinafter.

### BRIEF DESCRIPTION OF THE DRAWINGS

For better understanding of the present invention, reference is made to the attached drawings, wherein

FIG. 1 is a cross sectional view showing one step in a fabricating method of multilayered structure according to the present invention,

FIG. 2 is a cross sectional view showing the step after the step shown in FIG. 1,

FIG. 3 is a schematic view showing a multilayered structure according to the present invention, and

FIG. 4 is a cross sectional TEM photograph of a multilayered structure according to the present invention.

### DESCRIPTION OF THE PREFERRED EMBODIMENTS

This invention will be described in detail hereinafter.

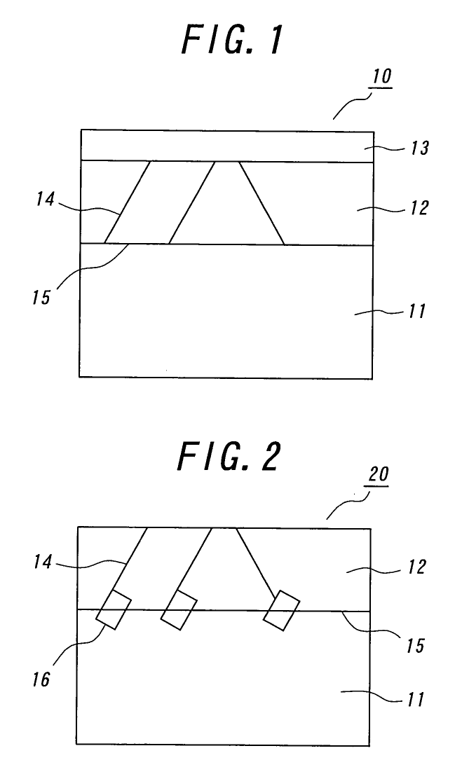

FIGS. 1 and 2 are explanatory views for a fabricating method of thin line structure according to the present invention. As shown in FIG. 1, first of all, a silicon base 11 is prepared, and a silicon germanium layer 12 is epitaxially grown on the silicon base 11 by means of a conventional film-forming technique. In this case, the silicon base 11 is heated within 400-700° C.

Since a given amount of germanium is contained in the silicon germanium layer 12, the lattice constant of the silicon germanium layer 12 becomes larger than the lattice constant of the silicon base 11. In order to epitaxially grow the silicon germanium layer 12 on the silicon base 11, it is required to compensate the difference in lattice constant between the silicon base 11 and the silicon germanium layer 12. In this case, misfit dislocations are created at the boundary face 15 between the silicon base 11 and the silicon germanium layer 12, and then, propagated through the epitaxially growing layer 12, to form penetrated dislocations 14 in the epitaxially grown layer 12.

Then, a metallic layer 13 is formed on the silicon germanium layer 12 to form a multilayered intermediate structure 10, which is heated. In this case, metallic elements of the metallic layer 13 are diffused to the boundary face 15 through the penetrated dislocations 14, and chemically reacted with silicon elements of the silicon base 11 and/or the silicon germanium layer 12, to form a thin line structure 16 made of metallic silicide at the boundary face 15 and thus, to form a multilayered structure 20 made of the silicon base 11, the silicon germanium layer 12 and the thin line structure 16.

In FIG. 2, although the metallic layer 13 disappeared, it may be rendered partially remained.

If necessary, the silicon germanium layer 12 can be peeled off by means of a conventional technique such as a lift-off method or an etching method, to expose the thin line structure 16. As a result, various semiconductor elements can be fabricated by utilizing the thin line structure 16.

The density of the thin line structure 16 at the boundary face 15 is not restricted, and can be controlled by adjusting the density of the penetrated dislocations 14. The density of the penetrated dislocations 14 is not restricted, but preferably set within 10⁻¹²-10⁻⁸/cm². In this case, the thin line structure 16 can be formed precisely in high density.

As mentioned above, the density of the penetrated dislocations 14 can be adjusted by controlling the forming method and the forming condition of the silicon germanium layer 12. The density of the penetrated dislocations 14 can be also adjusted by controlling the germanium content of the silicon germanium layer 12. In order to change the density of the penetrated dislocations 14 widely, it is desired to control the germanium content of the silicon germanium layer 12. In order to realize the above-mentioned range of the density of the penetrated dislocations 14, the germanium content is preferably set within 20-70 atomic percentages.

Although the penetrated dislocations 14 are created along various crystal orientations of the silicon base 11, if the forming condition and the like of the silicon germanium layer 12 are controlled, they can be created mainly along the crystal orientation <011> of the silicon base 11. Therefore, the thin line structure 16 can be formed regularly at the boundary face 15 along the same <011> crystal orientation.

The metallic layer 13 can be made of any kind of metallic material, but preferably made of a metallic material containing metallic elements with large affinity for silicon elements. In this case, through the chemical reaction between the silicon elements of the silicon base 11 and/or the silicon germanium layer 12 and the metallic elements of the metallic layer 13, the separation of the silicon elements from the base 11 and layer 12 is facilitated, and thus, the thin line structure 16 can be formed easily.

As the metallic elements are exemplified Ni elements, Co elements, Ti elements, Pt elements, Fe elements and Pd elements. If the metallic layer 13 contains such metallic elements as mentioned above, the thin line structure 16 can be easily made of a metallic silicide containing the metallic elements.

The above-mentioned metallic elements is like to be epitaxially grown in the silicon base 11, so the thin line structure 16 is also like to be formed in the silicon base 11. After the formation of the thin line structure 16, therefore, the boundary face 15 can be maintained plane in atomic level, so that the resultant multilayered structure is rendered very exquisite.

Among the metallic elements as mentioned above, the Ni elements can be preferably employed because Ni is generally employed as an electrode material for semiconductor elements. In this case, the thin line structure 16 is made of nickel silicide containing NiSi phase and/or NiSi₂ phase shifted from NiSi phase.

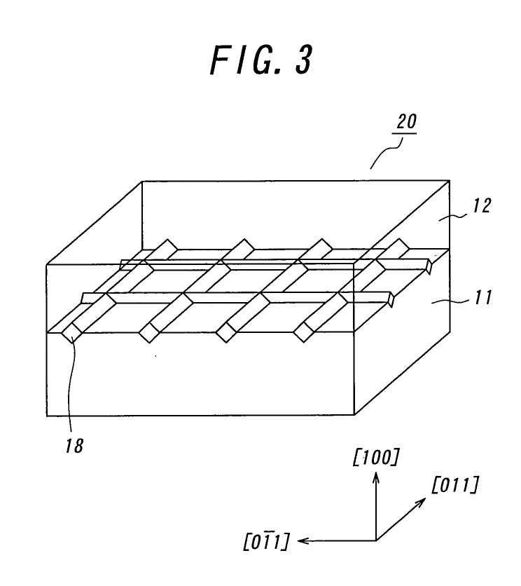

FIG. 3 is a perspective view schematically showing the multilayered structure 20 fabricated through the above-mentioned process. As shown in FIG. 3, if the thin line structure 16 is formed in lattice, a pattern 18 made of the metallic silicide can be formed on the silicon base 11.

### EXAMPLE

This invention will be described in detail, with reference to a concrete embodiment.

### (EXAMPLE)

First of all, a (100) silicon base was prepared, and heated at 600° C. Then, a Si_{0.53}Ge_{0.47} layer was epitaxially grown in a thickness of about 500 nm on the silicon base by means of CVD. Then, a Ni layer was formed in a thickness of 20 nm on the Si_{0.53}Ge_{0.47} layer by means of deposition using an electron gun, to form a multilayered intermediate structure, which was successively heated at 750° C. under nitrogen atmosphere until the Ni layer disappeared. In this case, the Ni elements of the Ni layer was diffused to the boundary face between the silicon base and the Si_{0.53}Ge_{0.47} layer through the penetrated dislocations of the Si_{0.53}Ge_{0.47} layer.

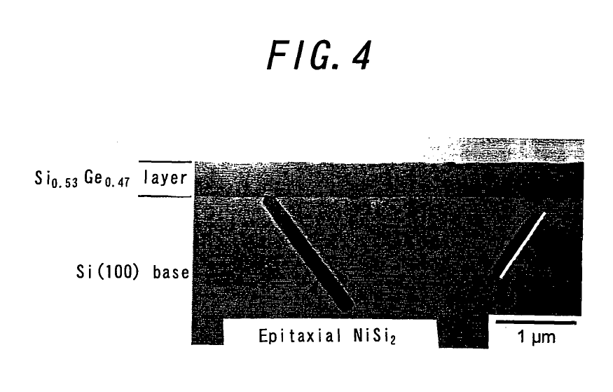

FIG. 4 is a cross sectional TEM photograph of the resultant multilayered structure fabricated through the above-mentioned process. It was confirmed in FIG. 4 that a thin line structure was made of nickel silicide with NiSi₂ phase at the boundary face between the (100) silicon base and the Si_{0.53}Ge_{0.47} layer. According to the present invention, it is turned out that the intended thin line structure can be easily made only by the strain-relaxed silicon germanium layer with the penetrated dislocations without a conventional complicated technique.

Although the present invention was described in detail with reference to the above examples, this invention is not limited to the above disclosure and every kind of variation and modification may be made without departing from the scope of the present invention.

What is claimed is:

1. A method for fabricating a thin line structure, comprising the steps of:
preparing a given silicon base,
forming, on said silicon base, a strain-relaxed silicon germanium layer with penetrated dislocations,
forming a metallic layer on said silicon germanium layer to form a multilayered intermediate structure which is made of said silicon base, said silicon germanium layer and said metallic layer,
and
heating said multilayered intermediate structure to diffuse metallic elements of said metallic layer through said penetrated dislocations of said silicon germanium layer and to form a thin line structure made of metallic silicide at a boundary face between said silicon base and said silicon germanium layer.

2. The fabricating method as defined in claim 1, wherein the density of said penetrated dislocations of said silicon germanium layer is set within 10⁻¹²-10⁻⁸/cm².

3. The fabricating method as defined in claim 2, wherein the germanium content of said silicon germanium layer is set within 20-70 atomic percentages.

4. The fabricating method as defined in claim 1, wherein said thin line structure is formed along the <011> crystal orientation of silicon crystal.

5. The fabricating method as defined in claim 1, wherein said metallic layer is made of at least one selected from the group consisting of Ni, Co, Ti, Pt, Fe and Pd.

6. The fabricating method as defined in claim 5, wherein said metallic layer is made of Ni.

7. The fabricating method as defined in claim 6, wherein said thin line structure is made of nickel silicide with at least one of NiSi phase and NiSi₂ phase.

8. A multilayered structure comprising:
a given silicon base,
a strain-relaxed silicon germanium layer with penetrated dislocations which is formed on said silicon base,
and
a thin line structure made of metallic silicide which is formed at a boundary face between said silicon base and silicon germanium layer.

9. The multilayered structure as defined in claim 8, wherein the density of said penetrated dislocations of said silicon germanium layer is within 10⁻¹²-10⁻⁸/cm².

10. The multilayered structure as defined in claim 9, wherein the germanium content of said silicon germanium layer is within 20-70 atomic percentages.

11. The multilayered structure as defined in claim 8, wherein said thin line structure is along the <011> crystal orientation of silicon crystal.

12. The multilayered structure as defined in claim 8, wherein said thin line structure is made of metallic silicide containing at least one selected from the group consisting of Ni, Co, Ti, Pt, Fe and Pd.

13. The multilayered structure as defined in claim 12, wherein said thin line structure is made of nickel silicide.

14. The multilayered structure as defined in claim 13, wherein said nickel silicide contains at least one of NiSi phase and NiSi₂ phase.

15. A multilayered intermediate structure comprising:
a given silicon base,
a strain-relaxed silicon germanium layer with penetrated dislocations which is formed on said silicon base,
and
a metallic layer which is formed on said silicon germanium layer.

16. The multilayered intermediate structure as defined in claim 15, wherein the density of said penetrated dislocations of said silicon germanium layer is within 10⁻¹²-10⁻⁸/cm².

17. The multilayered intermediate structure as defined in claim 16, wherein the germanium content of said silicon germanium layer is within 20-70 atomic percentages.

18. The multilayered intermediate structure as defined in claim 15, wherein said metallic layer is made of at least one selected from the group consisting of Ni, Co, Ti, Pt, Fe and Pd.

19. The multilayered intermediate structure as defined in claim 18, wherein said metallic layer is made of Ni.
